(19) United States
(12) Patent Application Publication
(10) Pub. No.: US 2021/0101446 A1
(43) Pub. Date: Apr. 8, 2021

(54) TEMPERATURE ADJUSTMENT DEVICE CONTROLLER FOR CONVERTIBLE VEHICLE

(71) Applicants: Toyota Jidosha Kabushiki Kaisha, Toyota-shi Aichi-ken (JP); Denso Corporation, Kariya-city (JP)

(72) Inventors: Toshiki Nakanishi, Toyota-shi (JP); Kozo Matsumoto, Nisshin-shi (JP); Takashi Kubokura, Toyota-shi (JP); Motoki Tatara, Nisshin-shi (JP); Hiroshi Yamaguchi, Kariya-shi (JP); Shinji Umeki, Kariya-shi (JP); Kenji Ishida, Kariya-shi (JP); Shunsuke Tanaka, Kariya-shi (JP); Naoki Mizutani, Kariya-shi (JP)

(73) Assignees: Toyota Jidosha Kabushiki Kaisha, Toyota-shi Aichi-ken (JP); Denso Corporation, Kariya-city (JP)

(21) Appl. No.: 17/063,265

(22) Filed: Oct. 5, 2020

(30) Foreign Application Priority Data
Oct. 7, 2019 (JP) 2019-184755

(51) Int. Cl. B60H 1/00

(52) U.S. Cl. CPC B60H 1/00764; B60H 1/00878

(57) ABSTRACT

A temperature adjustment device controller is configured to determine a temperature adjustment control basic value from a necessary temperature adjustment control amount calculated based on a parameter including environmental information, set a target blowing temperature of temperature adjustment air based on the temperature adjustment control basic value, and set a target blowing amount of the temperature adjustment air based on the temperature adjustment control basic value, an open-closed state of a movable roof, and a vehicle speed.

### CROSS-REFERENCE TO RELATED APPLICATIONS

This application claims priority to Japanese Patent Application No. 2019-184755 filed on Oct. 7, 2019, which is incorporated herein by reference in its entirety including the specification, drawings and abstract.

### BACKGROUND

### 1. Technical Field

The disclosure relates to a temperature adjustment device controller for a convertible vehicle (also referred to as a cabriolet). In particular, the disclosure relates to an improvement in temperature adjustment control for automatically controlling a blowing temperature and a blowing amount of temperature adjustment air.

### 2. Description of Related Art

In a convertible vehicle having a movable roof that is openable and closable, a blowing temperature and a blowing amount of temperature adjustment air to be blown from a temperature adjustment device are controlled depending on a state of the movable roof (open or closed). Therefore, comfort in a vehicle cabin can be kept satisfactorily even if the movable roof is open (in a situation in which the amount of outside air flowing into the vehicle cabin increases).

Japanese Patent No. 4886786 (JP 4886786 B) discloses a controller for a temperature adjustment device (such as a vehicle cabin air conditioner, a neck heater, or a seat air conditioner) of a convertible vehicle. When a movable roof is open, the amount of outside air flowing into a vehicle cabin changes depending on a vehicle speed. Considering this fact, a temperature adjustment operation switch (referred to as an air conditioning operation switch in JP 4886786 B) is turned ON to automatically control a blowing temperature and a blowing amount of temperature adjustment air based on the vehicle speed and an outside air temperature. When the movable roof is closed, the temperature adjustment operation switch is turned OFF to automatically control the temperature adjustment device irrespective of the vehicle speed.

### SUMMARY

In the controller disclosed in JP 4886786 B, there is no explicit description of a specific control method in the temperature adjustment control when the movable roof is closed. If the temperature adjustment control when the movable roof is open and the temperature adjustment control when the movable roof is closed are performed by different methods, the temperature adjustment condition of the temperature adjustment device may change significantly in response to a change in the state of the movable roof (before and after the movable roof is opened or closed) during the operation of opening or closing the movable roof. Thus, an occupant may feel discomfort.

The disclosure provides a temperature adjustment device controller for a convertible vehicle, which can perform temperature adjustment control without causing discomfort in an occupant irrespective of whether a movable roof is open or closed.

A first aspect of the disclosure relates to a temperature adjustment device controller. The temperature adjustment device controller is configured to control a blowing temperature and a blowing amount of temperature adjustment air to be blown into a vehicle cabin from a temperature adjustment device mounted on a convertible vehicle having a movable roof that is openable and closable. The temperature adjustment device controller includes a parameter acquisition unit, a necessary temperature adjustment control amount calculation unit, a temperature adjustment control basic value determination unit, roof opening-closing switch, vehicle speed detection sensor, a target blowing temperature setting unit, and a target blowing amount setting unit. The parameter acquisition unit is configured to acquire a parameter including environmental information. The necessary temperature adjustment control amount calculation unit is configured to calculate a necessary temperature adjustment control amount based on the parameter acquired by the parameter acquisition unit. The temperature adjustment control basic value determination unit is configured to determine a temperature adjustment control basic value based on the necessary temperature adjustment control amount calculated by the necessary temperature adjustment control amount calculation unit. The roof opening-closing switch is configured to output an output signal depending on an open-closed state of the movable roof. The vehicle speed detection sensor is configured to detect a vehicle speed. The target blowing temperature setting unit is configured to set a target blowing temperature of the temperature adjustment air based on the temperature adjustment control basic value determined by the temperature adjustment control basic value determination unit. The target blowing amount setting unit is configured to set a target blowing amount of the temperature adjustment air based on the temperature adjustment control basic value determined by the temperature adjustment control basic value determination unit, the open-closed state of the movable roof that is output by the roof opening-closing switch, and the vehicle speed detected by the vehicle speed detection sensor.

According to the specifying matters described above, to control the blowing temperature and the blowing amount of the temperature adjustment air to be blown into the vehicle cabin from the temperature adjustment device, the parameter including the environmental information is acquired, and the necessary temperature adjustment control amount is calculated based on the parameter. The temperature adjustment control basic value is determined based on the necessary temperature adjustment control amount. The target blowing temperature of the temperature adjustment air is set based on the determined temperature adjustment control basic value. The open-closed state of the movable roof is recognized, and the vehicle speed is detected. The target blowing amount of the temperature adjustment air is set based on the temperature adjustment control basic value, the open-closed state of the movable roof, and the vehicle speed.

The blowing temperature and the blowing amount of the temperature adjustment air to be blown into the vehicle cabin from the temperature adjustment device are automatically controlled in this manner. Therefore, the blowing temperature of the temperature adjustment air is controlled based on the temperature adjustment control basic value determined as described above. Further, the blowing amount of the temperature adjustment air when the movable roof is open or the blowing amount of the temperature adjustment air when the movable roof is closed is controlled based on the temperature adjustment control basic value determined as described above (based on the temperature adjustment control basic value, the open-closed state of the movable roof, and the vehicle speed). That is, each control is performed based on the temperature adjustment control basic value. Therefore, when the movable roof is opened or closed, the temperature adjustment condition of the temperature adjustment device does not change significantly in response to the change in the state of the movable roof (before and after the movable roof is opened or closed). As a result, discomfort of the occupant is suppressed. Thus, the temperature adjustment control can be performed without causing discomfort in the occupant irrespective of whether the movable roof is open or closed. The temperature adjustment control is automatically performed by the target blowing temperature setting unit and the target blowing amount setting unit, and therefore the occupant is not forced to perform a burdensome operation. Thus, a highly useful temperature adjustment device controller can be provided.

In the first aspect described above, the temperature adjustment device may be configured to blow temperature adjustment air for warming into the vehicle cabin. The parameter including the environmental information may be an environmental temperature including at least one of a temperature in the vehicle cabin and an outside air temperature. The temperature adjustment device controller may be configured to, as the environmental temperature decreases relative to a set temperature of the temperature adjustment air that is requested by an occupant, set the necessary temperature adjustment control amount calculated by the necessary temperature adjustment control amount calculation unit to a larger value, such that the temperature adjustment device controller increases the target blowing temperature of the temperature adjustment air set by the target blowing temperature setting unit and increases the target blowing amount of the temperature adjustment air set by the target blowing amount setting unit.

There is a tendency that the warming request of the occupant is at a higher level as the environmental temperature decreases relative to the set temperature of the temperature adjustment air that is requested by the occupant. In this case, the necessary temperature adjustment control amount is calculated as a larger value to increase the target blowing temperature and the target blowing amount of the temperature adjustment air, thereby sufficiently responding to the warming request of the occupant.

In the first aspect described above, the temperature adjustment device may be configured to blow temperature adjustment air for warming into the vehicle cabin. The parameter including the environmental information may be a solar radiation amount in the vehicle cabin. The temperature adjustment device controller may be configured to, as the solar radiation amount decreases, set the necessary temperature adjustment control amount calculated by the necessary temperature adjustment control amount calculation unit to a larger value, such that the temperature adjustment device controller increases the target blowing temperature of the temperature adjustment air set by the target blowing temperature setting unit and increases the target blowing amount of the temperature adjustment air set by the target blowing amount setting unit.

There is a tendency that the warming request of the occupant is at a higher level as the solar radiation amount decreases, for example, in winter. In this case as well, the necessary temperature adjustment control amount is calculated as a larger value to increase the target blowing temperature and the target blowing amount of the temperature adjustment air, thereby sufficiently responding to the warming request of the occupant.

In the first aspect described above, the temperature adjustment device may be configured to blow temperature adjustment air for warming into the vehicle cabin. The parameter including the environmental information may be a humidity in the vehicle cabin. The temperature adjustment device controller may be configured to, as the humidity increases, set the necessary temperature adjustment control amount calculated by the necessary temperature adjustment control amount calculation unit to a smaller value, such that the temperature adjustment device controller reduces the target blowing temperature of the temperature adjustment air set by the target blowing temperature setting unit and reduces the target blowing amount of the temperature adjustment air set by the target blowing amount setting unit.

For example, in winter, the occupant may feel discomfort when temperature adjustment air having a relatively high temperature is blown toward the occupant but the humidity of the temperature adjustment air is high. When the humidity in the vehicle cabin is high, the necessary temperature adjustment control amount is calculated as a smaller value to reduce the target blowing temperature and the target blowing amount of the temperature adjustment air, thereby suppressing discomfort of the occupant.

In the first aspect described above, the temperature adjustment device controller may be configured to, when the open-closed state of the movable roof that is recognized based on the output signal from the roof opening-closing switch is an open state rather than a closed state, perform control so as to increase the target blowing amount of the temperature adjustment air set by the target blowing amount setting unit, even if the temperature adjustment control basic value determined by the temperature adjustment control basic value determination unit is the same.

The amount of outside air flowing into the vehicle cabin increases when the open-closed state of the movable roof is the open state rather than the closed state. The temperature adjustment request of the occupant is sufficiently met by increasing the target blowing amount of the temperature adjustment air.

In the first aspect described above, the temperature adjustment device controller may be configured to, when the open-closed state of the movable roof that is recognized based on the output signal from the roof opening-closing switch is an open state, perform control so as to increase the target blowing amount of the temperature adjustment air set by the target blowing amount setting unit increases as the vehicle speed detected by the vehicle speed detection sensor, even if the temperature adjustment control basic value determined by the temperature adjustment control basic value determination unit is the same.

When the open-closed state of the movable roof is the open state, the amount of outside air flowing into the vehicle cabin may increase as the vehicle speed increases. The temperature adjustment request of the occupant is sufficiently met by increasing the target blowing amount of the temperature adjustment air.

In the first aspect described above, the temperature adjustment device may be a neck heater provided in a head rest of a seat in the vehicle cabin and configured to blow the temperature adjustment air forward from the head rest.

The neck heater is a temperature adjustment device configured to blow the temperature adjustment air toward the neck of the occupant in the vehicle to secure comfort around the neck of the occupant. The comfort around the neck of the occupant can sufficiently be secured by applying the temperature adjustment device controller described above to the neck heater. The temperature adjustment control for the neck heater is automatically performed by the target blowing temperature setting unit and the target blowing amount setting unit, and therefore the occupant is not forced to perform a burdensome operation.

The temperature adjustment device controller of the first aspect described above may further include a target blowing temperature reduction unit configured to change the target blowing temperature to a lower temperature under a condition that an elapsed time reaches a predetermined time in a state where the target blowing temperature is equal to or higher than a predetermined temperature.

If the blowing temperature of the temperature adjustment air from the neck heater is relatively high continuously for a long time, the occupant may be affected adversely. Therefore, the target blowing temperature is changed to a lower temperature under the condition that the elapsed time reaches the predetermined time in the state in which the target blowing temperature is equal to or higher than the predetermined temperature. Thus, it is possible to suppress the adverse effect on the occupant that may be caused by the temperature adjustment air from the neck heater.

The temperature adjustment device controller of the first aspect described above may further include a necessary temperature adjustment control amount correction unit configured to receive customization information for the temperature adjustment air that is input through a manual operation by an occupant, and correct the necessary temperature adjustment control amount based on the customization information.

When the occupant desires to change the blowing temperature and the blowing amount of the temperature adjustment air from the temperature adjustment device, the occupant performs a manual operation (for example, an operation on a display provided in the vehicle cabin) to transmit the customization information for the temperature adjustment air toward the necessary temperature adjustment control amount correction unit. When the necessary temperature adjustment control amount correction unit receives the customization information, the necessary temperature adjustment control amount calculated by the necessary temperature adjustment control amount calculation unit is corrected based on the customization information (in response to the request made through the manual operation by the occupant). Thus, the request to change the temperature adjustment air from the occupant can be met.

In the first aspect described above, the temperature adjustment device controller may be configured to adjust control parameters of temperature adjustment devices mounted on the convertible vehicle based on the necessary temperature adjustment control amount calculated by the necessary temperature adjustment control amount calculation unit.

Thus, when the movable roof is opened or closed, the temperature adjustment conditions of the temperature adjustment devices mounted on the convertible vehicle do not change significantly in response to the change in the state of the movable roof (before and after the movable roof is opened or closed). As a result, discomfort of the occupant is suppressed. Thus, the temperature adjustment control can be performed without causing discomfort in the occupant irrespective of whether the movable roof is open or closed.

A second aspect of the disclosure relates to a temperature adjustment device controller including at least one electronic control unit. The at least one electronic control unit is configured to: control a blowing temperature and a blowing amount of temperature adjustment air to be blown into a vehicle cabin from a temperature adjustment device mounted on a convertible vehicle having a movable roof that is openable and closable; acquire a parameter including environmental information; calculate a necessary temperature adjustment control amount based on the parameter; determine a temperature adjustment control basic value based on the necessary temperature adjustment control amount; output an output signal depending on an open-closed state of the movable roof; detect a vehicle speed; set a target blowing temperature of the temperature adjustment air based on the temperature adjustment control basic value; and set a target blowing amount of the temperature adjustment air based on the temperature adjustment control basic value, the open-closed state of the movable roof, and the vehicle speed.

In the second aspect described above, the temperature adjustment device may be configured to blow temperature adjustment air for warming into the vehicle cabin, and the parameter including the environmental information may be an environmental temperature including at least one of a temperature in the vehicle cabin and an outside air temperature. The temperature adjustment device controller may be configured to, as the environmental temperature decreases relative to a set temperature of the temperature adjustment air that is requested by an occupant, set the necessary temperature adjustment control amount calculated by the at least one electronic control unit to a larger value, such that the temperature adjustment device controller increases the target blowing temperature of the temperature adjustment air set by the at least one electronic control unit and increases the target blowing amount of the temperature adjustment air set by the at least one electronic control unit.

In the second aspect described above, the temperature adjustment device may be configured to blow temperature adjustment air for warming into the vehicle cabin, and the parameter including the environmental information may be a solar radiation amount in the vehicle cabin. The temperature adjustment device controller may be configured to, as the solar radiation amount decreases, set the necessary temperature adjustment control amount calculated by the at least one electronic control unit to a larger value, such that the temperature adjustment device controller increases the target blowing temperature of the temperature adjustment air set by the at least one electronic control unit and increases the target blowing amount of the temperature adjustment air set by the at least one electronic control unit.

In the second aspect described above, the temperature adjustment device may be configured to blow temperature adjustment air for warming into the vehicle cabin, and the parameter including the environmental information is a humidity in the vehicle cabin. The temperature adjustment device controller may be configured to, as the humidity increases, set the necessary temperature adjustment control amount calculated by the at least one electronic control unit to a smaller value, such that the temperature adjustment device controller reduces the target blowing temperature of the temperature adjustment air set by the at least one electronic control unit and reduces the target blowing amount of the temperature adjustment air set by the at least one electronic control unit.

In the second aspect described above, the temperature adjustment device controller may be configured to, when the open-closed state of the movable roof is an open state rather than a closed state, perform control the target blowing amount of the temperature adjustment air set by the at least one electronic control unit increases even if the temperature adjustment control basic value determined by the at least one electronic control unit is the same.

In the second aspect described above, the temperature adjustment device controller may be configured to, when the open-closed state of the movable roof is an open state, perform control the target blowing amount of the temperature adjustment air set by the at least one electronic control unit increases as the vehicle speed increases, even if the temperature adjustment control basic value determined by the at least one electronic control unit is the same.

In the second aspect described above, the temperature adjustment device may be a neck heater provided in a head rest of a seat in the vehicle cabin and configured to blow the temperature adjustment air forward from the head rest.

In the second aspect described above, the at least one electronic control unit may be configured to change the target blowing temperature to a lower temperature under a condition that an elapsed time reaches a predetermined time in a state where the target blowing temperature is equal to or higher than a predetermined temperature.

In the second aspect described above, the at least one electronic control unit may be configured to receive customization information for the temperature adjustment air that is input through a manual operation by an occupant, and correct the necessary temperature adjustment control amount based on the customization information.

In the second aspect described above, the temperature adjustment device controller may be configured to adjust control parameters of temperature adjustment devices mounted on the convertible vehicle based on the necessary temperature adjustment control amount calculated by the at least one electronic control unit.

In the first aspect and the second aspect of the disclosure, the temperature adjustment control basic value is determined from the necessary temperature adjustment control amount calculated based on the parameter including the environmental information, and the target blowing temperature of the temperature adjustment air is set based on the temperature adjustment control basic value. Further, the target blowing amount of the temperature adjustment air is set based on the temperature adjustment control basic value, the open-closed state of the movable roof, and the vehicle speed. Therefore, when the movable roof is opened or closed, the temperature adjustment condition of the temperature adjustment device does not change significantly in response to the change in the state of the movable roof. As a result, discomfort of the occupant is suppressed. Thus, the temperature adjustment control can be performed without causing discomfort in the occupant irrespective of whether the movable roof is open or closed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating the overall configuration of a temperature adjustment system mounted on a convertible vehicle according to an embodiment;

FIG. 2 is a diagram for describing a neck heater;

FIG. 3 is a diagram illustrating the overall structure of a vehicle cabin air conditioner;

FIG. 4 is a diagram for describing mode switching through an occupant's display operation;

FIG. 5 is a diagram illustrating an example of an automatic mode customization setting table;

FIG. 6 is a diagram illustrating an example of a temperature adjustment control basic value determination map;

FIG. 7 is a diagram illustrating an example of a temperature adjustment control table;

FIG. 8 is a diagram illustrating an example of a manual mode customization setting table;

FIG. 9 is a flowchart for describing a procedure of neck heater control; and

FIG. 10 is a flowchart for describing a procedure of neck heater temperature reduction control.

### DETAILED DESCRIPTION OF EMBODIMENTS

An embodiment of the disclosure is described below with reference to the drawings. In this embodiment, description is given of a case where the disclosure is applied to a controller (temperature adjustment device controller) configured to control a blowing temperature and a blowing amount of temperature adjustment air to be blown from a neck heater serving as a temperature adjustment device mounted on a convertible vehicle.

### Overall Configuration of Temperature Adjustment System

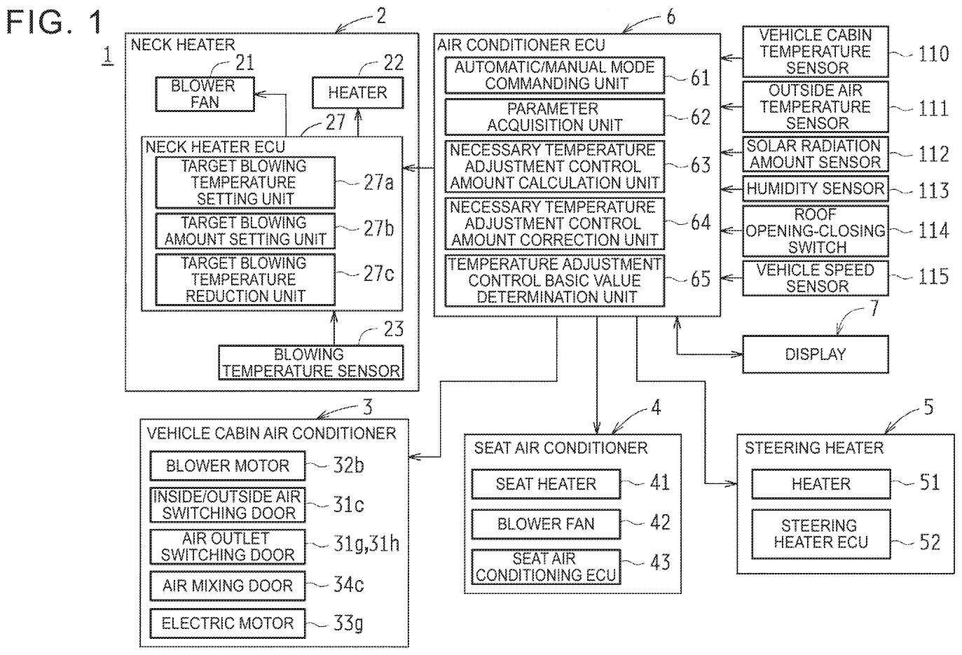

FIG. 1 is a block diagram illustrating the overall configuration of a temperature adjustment system 1 mounted on a convertible vehicle according to this embodiment. As illustrated in FIG. 1, the temperature adjustment system 1 controls a plurality of temperature adjustment devices integrally or individually. The temperature adjustment devices provided in the temperature adjustment system 1 are a neck heater 2, a vehicle cabin air conditioner (car air conditioner) 3, a seat air conditioner 4, and a steering heater 5. The temperature adjustment devices 2, 3, 4, and 5 are connected to an air conditioner electronic control unit (ECU) 6, and are controlled automatically (controlled in an automatic mode) or manually (controlled in a manual mode) by receiving information (such as temperature adjustment control basic value information and mode command information described later) from the air conditioner ECU 6. The temperature adjustment devices 2, 3, 4, and 5 are described below.

### Neck Heater

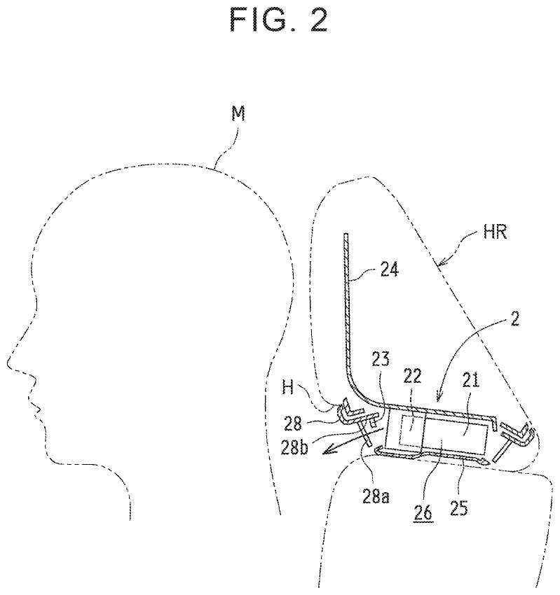

FIG. 2 is a diagram for describing the neck heater 2. The neck heater 2 is a temperature adjustment device housed in a head rest HR of a front seat of the vehicle (driver's seat or passenger's seat) and configured to blow temperature adjustment air (warm air) toward the neck of an occupant (represented by a hidden outline M in FIG. 2) to secure comfort around the neck of the occupant M.

As illustrated in FIG. 2, the neck heater 2 includes a blower fan 21, a heater 22, and a blowing temperature sensor 23 provided in the head rest HR.

Specifically, the blower fan 21 and the heater 22 are housed in a neck heater housing space 26 formed between an insertion bezel 25 and a base member 24 provided in the head rest HR and made from resin.

The blower fan 21 is an electric fan, and sends air toward the heater 22 by operating in response to an airflow amount command signal from a neck heater ECU 27 (see FIG. 1). The airflow amount command signal from the neck heater ECU 27 is a signal for switching a rotation speed of the blower fan 21 (air sending amount) in multiple levels (for example, a pulse width modulation (PWM) signal). The rotation speed of the blower fan 21 is controlled by the airflow amount command signal.

The heater 22 is a positive temperature coefficient (PTC) heater, and operates in response to a temperature command signal from the neck heater ECU 27. The temperature command signal from the neck heater ECU 27 is a signal for switching a heat generation amount of the heater 22 in multiple levels. The heat generation amount of the heater 22 is controlled by the temperature command signal.

Details of the control for the blower fan 21 and the heater 22 in the neck heater 2 are described later.

In the front of the head rest HR, an opening H is formed at a part corresponding to an air outlet of the heater 22. An air outlet cap 28 is attached to the opening H. The air outlet cap 28 is a member that guides temperature adjustment air blown through the air outlet of the heater 22 to a portion around the neck of the occupant M. The air outlet cap 28 is provided with a fin 28a for suppressing the occupant M from directly touching the heater 22. A mesh-like member may be provided in place of the fin 28a.

The blowing temperature sensor (thermistor) 23 is attached to the inner surface of the air outlet cap 28 to detect the temperature of temperature adjustment air blown from the heater 22. The blowing temperature sensor 23 is attached to a ceiling surface 28b of the air outlet cap 28 (upper surface in a space where the temperature adjustment air flows). The position where the blowing temperature sensor 23 is attached is not limited to the ceiling surface 28b. Any position may be selected as long as the blowing temperature sensor 23 is not affected by radiation heat of the heater 22 and can detect the temperature of the blown temperature adjustment air.

### Vehicle Cabin Air Conditioner

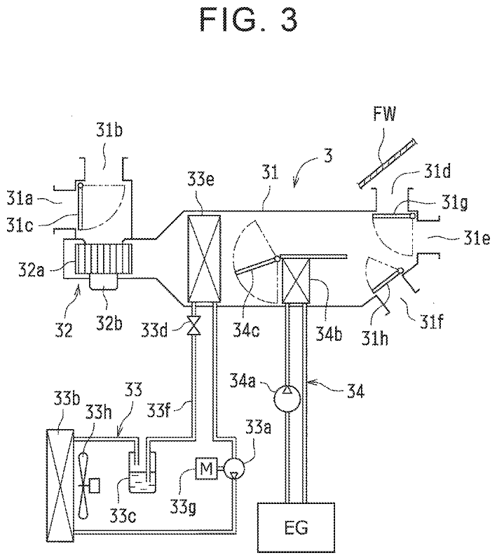

FIG. 3 is a diagram illustrating the overall structure of the vehicle cabin air conditioner 3. The vehicle cabin air conditioner 3 includes an air conditioning duct 31, a centrifugal blower 32, a refrigerant circulation circuit 33, and a coolant circuit 34. An air passage for guiding conditioning air into a vehicle cabin is formed in the air conditioning duct 31. The centrifugal blower 32 generates an airflow in the air conditioning duct 31. The refrigerant circulation circuit 33 cools air flowing through the air conditioning duct 31. The coolant circuit 34 heats air flowing through the air conditioning duct 31.

An air inlet switching box is formed at the end of an upstream side in the air conditioning duct 31. The air inlet switching box has an inside air inlet 31a and an outside air inlet 31b. Air inside the vehicle cabin (inside air) is taken into the air conditioning duct 31 through the inside air inlet 31a. Air outside the vehicle cabin (outside air) is taken into the air conditioning duct 31 through the outside air inlet 31b. An inside/outside air switching door 31c is turnably attached on an inner side of the inside air inlet 31a and the outside air inlet 31b. The inside/outside air switching door 31c is driven by an actuator such as a servomotor to switch an air inlet mode between an inside air circulation mode and an outside air introduction mode.

An air outlet switching box is formed at the end of a downstream side in the air conditioning duct 31. The air outlet switching box has a defroster (DEF) opening 31d, a face opening 31e, and a foot opening 31f.

Conditioning air is blown through the DEF opening 31d toward the inner surface of a windshield FW of the vehicle. The conditioning air is blown through the face opening 31e toward the head and chest of the occupant M. The conditioning air is blown through the foot opening 31f toward the feet of the occupant M.

Air outlet switching doors 31g and 31h are turnably attached on an inner side of the openings 31d, 31e, and 31f. The air outlet switching doors 31g and 31h are driven by actuators such as servomotors to switch an air outlet mode to a face mode, a bi-level (B/L) mode, a foot mode, a foot/defroster (F/D) mode, or a defroster (DEF) mode.

The centrifugal blower 32 includes a blower 32a and a blower motor 32b. The blower 32a is rotatably housed in a scroll case integrated with the air conditioning duct 31. The blower motor 32b drives the blower 32a to rotate.

The blower airflow amount (rotation speed of the blower 32a) is controlled by using the blower motor 32b based on a blower terminal voltage applied via a blower drive circuit.

The refrigerant circulation circuit 33 includes a compressor 33a, a condenser 33b, a receiver 33c, an expansion valve 33d, an evaporator 33e, and refrigerant pipes 33f connecting those components into a ring.

The evaporator 33e is provided at a part of the air passage in its longitudinal direction to cross the passage.

The compressor 33a compresses and discharges sucked refrigerant. The compressor 33a is an electric compressor to be driven by an electric motor 33g. The refrigerant circulates through the refrigerant circulation circuit 33 by power generated along with an operation of the electric motor 33g and transmitted to the compressor 33a. Therefore, air is cooled along with evaporation and gasification of the refrigerant in the evaporator 33e. The compressor 33a may be driven by power of an engine EG.

The condenser 33b condenses and liquefies the refrigerant compressed by the compressor 33a. Specifically, the condenser 33b condenses and liquefies the refrigerant by exchanging heat between the refrigerant and outside air sent by a cooling fan 33h or traveling air (while the vehicle is traveling).

The coolant circuit 34 is configured such that a water pump 34a circulates a coolant warmed in a water jacket of the engine EG. The coolant circuit 34 includes a heater core 34b.

The engine coolant flows through the heater core 34b. The heater core 34b heats air by using the engine coolant as a heat source for warming. In addition to the heater core 34b, the coolant circuit 34 includes a radiator for releasing heat of the engine coolant to the atmosphere, and a thermostat for switching the circulation path of the coolant (illustration is omitted). Those components are known and therefore their description is omitted herein.

The heater core 34b is provided at a part of the air passage on a downstream side of the evaporator 33e.

An air mixing door 34c is turnably attached on an upstream side of the heater core 34b. The air mixing door 34c is driven by an actuator such as a servomotor to change the ratio between the amount of air passing through the heater core 34b and the amount of air bypassing the heater core 34b depending on a stop position of the air mixing door 34c that ranges from a maximum cool position where all the air bypasses the heater core 34b to a maximum hot position where all the air passes through the heater core 34b. Thus, the temperature of the air to be blown into the vehicle cabin is adjusted.

### Seat Air Conditioner

The seat air conditioner 4 includes seat heaters 41 configured to heat the seat, and blower fans 42 provided in the seat.

The seat heaters 41 are heating wires embedded in a seat cushion and a seatback. For example, in winter, the seat cushion and the seatback are heated by heat generated along with energization of the heating wires to increase comfort of the seated occupant M.

The blower fans 42 are embedded in the seat cushion and the seatback. For example, in summer, air is sent from the seat cushion and the seatback toward the occupant M by energizing the blower fans 42 to increase comfort of the seated occupant M.

The seat heaters 41 and the blower fans 42 are controlled by a seat air conditioning ECU 43. The seat air conditioning ECU 43 controls the seat heaters 41 and the blower fans 42 by receiving information from the air conditioner ECU 6 (such as temperature adjustment control basic value information and mode command information described later). A temperature command signal from the seat air conditioning ECU 43 is a signal for switching a heat generation amount of each seat heater 41 in multiple levels. The heat generation amount of each seat heater 41 is controlled by the temperature command signal. An airflow amount command signal from the seat air conditioning ECU 43 is a signal for switching a rotation speed of each blower fan 42 (air sending amount) in multiple levels. The rotation speed of each blower fan 42 is controlled by the airflow amount command signal.

### Steering Heater

The steering heater 5 includes a heater 51 that is a heating wire provided in a steering wheel. For example, in winter, the steering heater 5 heats the steering wheel by heat generated along with energization of the heater 51 to increase comfort of the occupant (driver) M who grips the steering wheel.

The heater 51 is controlled by a steering heater ECU 52. The steering heater ECU 52 controls the heater 51 by receiving information from the air conditioner ECU 6 (such as temperature adjustment control basic value information and mode command information described later). A temperature command signal from the steering heater ECU 52 is a signal for switching a heat generation amount of the heater 51 in multiple levels. The heat generation amount of the heater 51 is controlled by the temperature command signal.

### Air Conditioner ECU

The air conditioner ECU 6 is generally a publicly-known ECU, and includes a central processing unit (CPU), a read only memory (ROM), a random access memory (RAM), and a backup RAM though illustration is omitted.

The air conditioner ECU 6 of this embodiment not only controls the vehicle cabin air conditioner 3 (controls various actuators) but also outputs control information to the neck heater 2, the seat air conditioner 4, and the steering heater 5 that are the other temperature adjustment devices. Thus, the temperature adjustment devices 2, 4, and 5 are controlled by the respective ECUs 27, 43, and 52 based on the control information.

Specifically, a display 7 is connected to the air conditioner ECU 6. The display 7 is provided on a front side in the vehicle cabin (instrument panel). Operation information is input based on an operation for the display 7 by the occupant M.

Various switches such as automatic mode switches, manual mode switches, and customization switches are displayed on the display 7. The automatic mode switches are used for automatically controlling the temperature adjustment devices 2, 3, 4, and 5. The manual mode switches are used for manually controlling (manually operating) the temperature adjustment devices 2, 3, 4, and 5. The customization switches are used for adjusting temperature adjustment conditions of the temperature adjustment devices 2, 3, 4, and 5 through manual operations (the occupant M adjusts the temperature adjustment conditions of the temperature adjustment devices through manual operations when the occupant M desires to change the temperature adjustment conditions). Those switches can be displayed for each of the temperature adjustment devices 2, 3, 4, and 5. The temperature adjustment devices 2, 3, 4, and 5 can individually be switched between the automatic mode and the manual mode. Further, the temperature adjustment conditions of the temperature adjustment devices 2, 3, 4, and 5 can individually be adjusted (for example, a Low (Lo) mode, a Middle (Mid) mode, and a High (Hi) mode can be switched as described later).

A fully automatic mode switch can also be displayed on the display 7. The fully automatic mode switch is used for operating all the temperature adjustment devices 2, 3, 4, and 5 in the automatic mode. When the fully automatic mode switch is pressed, all the temperature adjustment devices 2, 3, 4, and 5 operate in the automatic mode together. Details of temperature adjustment control in the automatic mode and temperature adjustment control in the manual mode are described later.

Various sensors such as a vehicle cabin temperature sensor 110, an outside air temperature sensor 111, a solar radiation amount sensor 112, a humidity sensor 113, and a vehicle speed sensor 115 are connected to the air conditioner ECU 6. The vehicle cabin temperature sensor 110 detects a temperature in the vehicle cabin. The outside air temperature sensor 111 detects an outside air temperature. The solar radiation amount sensor 112 detects a solar radiation amount in the vehicle cabin. The humidity sensor 113 detects a humidity in the vehicle cabin. The vehicle speed sensor 115 detects a traveling speed of the vehicle. A roof opening-closing switch 114 is also connected to the air conditioner ECU 6. The roof opening-closing switch 114 is operated by the occupant M to open or close a movable roof of the vehicle. The air conditioner ECU 6 can grasp the state of the movable roof (open or closed) by receiving a signal output from the roof opening-closing switch 114 (movable roof opening command signal or movable roof closing command signal).

### Temperature Adjustment Control for Neck Heater

Next, description is given of temperature adjustment control for the neck heater 2, which is one feature of this embodiment. The temperature adjustment control for the neck heater 2 involves controlling a blowing temperature by controlling the heat generation amount of the heater 22 (controlling the temperature of temperature adjustment air to be blown through the opening H of the head rest HR), and controlling a blowing amount by controlling the rotation speed of the blower fan 21 (controlling the airflow amount of the temperature adjustment air to be blown through the opening H of the head rest HR).

Control modes for the blowing temperature control and the blowing amount control include a manual mode in which the control is performed through a manual operation by the occupant M, and an automatic mode in which the control is performed by the air conditioner ECU 6 and the neck heater ECU 27. The manual mode and the automatic mode are switched through an operation on a mode selection screen to be displayed on the display 7.

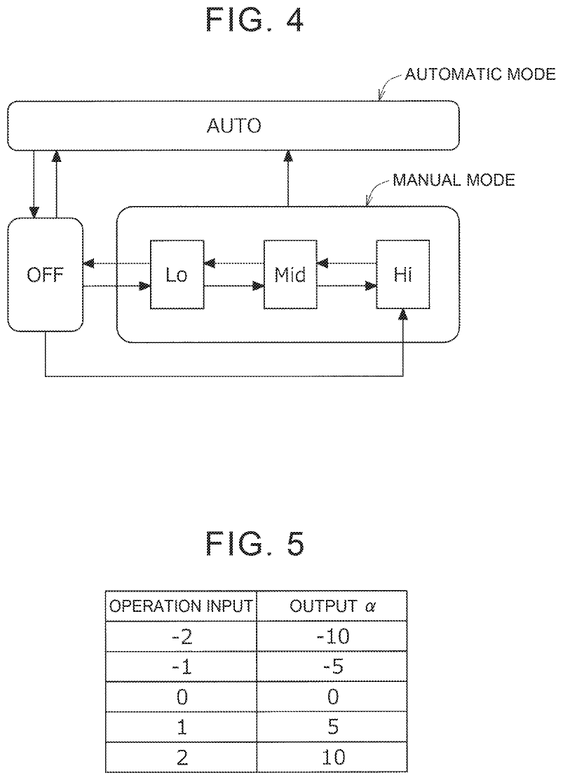

FIG. 4 is a diagram for describing mode switching through a display operation by the occupant M. As indicated by arrows in FIG. 4, the manual mode, the automatic mode, and “OFF” (stop of the operation of the neck heater 2) can be switched through the display operation by the occupant M. In the manual mode, the Lo mode, the Mid mode, and the Hi mode can be switched. Those modes are different in terms of the blowing temperature and the blowing amount. The Lo mode is selected when a temperature adjustment request of the occupant M (blowing temperature and blowing amount of requested temperature adjustment air) is at a relatively low level. The blowing temperature is set relatively low and the blowing amount is set relatively small within predetermined ranges (control ranges of the blowing temperature and the blowing amount of the temperature adjustment air in the neck heater 2). The Hi mode is selected when the temperature adjustment request of the occupant M is at a relatively high level. The blowing temperature is set relatively high and the blowing amount is set relatively large. The Mid mode is a mode between the Lo mode and the Hi mode. Each of the blowing temperature and the blowing amount is set to a value between the values in the Lo mode and the Hi mode. In the automatic mode, the Lo mode, the Mid mode, and the Hi mode are automatically set depending on a plurality of parameters including environmental information as described later. The blowing temperature and the blowing amount are set depending on the set mode.

This embodiment has a feature in an operation of setting the blowing temperature and the blowing amount in the automatic mode. A configuration for the setting operation is described below.

The air conditioner ECU 6 includes an automatic/manual mode commanding unit 61. When the automatic mode is selected through an operation on the display 7, the automatic/manual mode commanding unit 61 transmits an automatic mode command signal to operate the neck heater 2 in the automatic mode. When the manual mode is selected through the operation on the display 7, the automatic/manual mode commanding unit 61 transmits a manual mode command signal to operate the neck heater 2 in the manual mode.

The air conditioner ECU 6 includes a parameter acquisition unit 62, a necessary temperature adjustment control amount calculation unit 63, a necessary temperature adjustment control amount correction unit 64, and a temperature adjustment control basic value determination unit 65 which contribute to the setting operation for the blowing temperature and the blowing amount in the automatic mode.

The parameter acquisition unit 62 acquires parameters including environmental information. Specifically, the parameter acquisition unit 62 acquires a temperature in the vehicle cabin that is detected by the vehicle cabin temperature sensor 110, an outside air temperature detected by the outside air temperature sensor 111, a solar radiation amount detected by the solar radiation amount sensor 112, a humidity in the vehicle cabin that is detected by the humidity sensor 113, and a traveling speed of the vehicle (vehicle speed) that is detected by the vehicle speed sensor 115. The parameter acquisition unit 62 also acquires information on a set temperature that is set through a display operation by the occupant M (temperature in the vehicle cabin that is requested by the occupant M). The parameter acquisition unit 62 receives a signal output from the roof opening-closing switch 114 (movable roof opening command signal or movable roof closing command signal). By receiving the output signal, a current state of the movable roof (open or closed) can be grasped.

The necessary temperature adjustment control amount calculation unit 63 calculates a necessary temperature adjustment control amount (TAOBiseat) based on the parameters acquired by the parameter acquisition unit 62, and calculates a neck-heater necessary temperature adjustment control amount (NeckTAOi) based on the necessary temperature adjustment control amount (TAOBiseat). The neck-heater necessary temperature adjustment control amount (NeckTAOi) is a necessary control amount of temperature adjustment air to be blown from the neck heater 2 to attain a temperature adjustment condition currently requested by the occupant M.

The necessary temperature adjustment control amount (TAOBiseat) is calculated by calculating a basic term from Expression (1) and then applying the calculated basic term to Expression (2). The operation of calculating the necessary temperature adjustment control amount (TAOBiseat) is repeated and updated in every predetermined time.

Basic term=Set temperature term−Vehicle cabin temperature term−Outside air temperature term−Constant (1)

Necessary temperature adjustment control amount (TAOBiseat)=Basic term−Solar radiation amount correction term−Humidity correction term−Location correction term (2)

The set temperature term is a value defined by, for example, multiplying the set temperature that is set through the display operation by the occupant M by a coefficient set in advance for each type of vehicle. The vehicle cabin temperature term is a value defined by, for example, multiplying the temperature in the vehicle cabin that is detected by the vehicle cabin temperature sensor 110 by a coefficient set in advance for each type of vehicle. The outside air temperature term is a value defined by, for example, multiplying the outside air temperature detected by the outside air temperature sensor 111 by a coefficient set in advance for each type of vehicle. The solar radiation amount correction term is a value defined by, for example, multiplying the solar radiation amount detected by the solar radiation amount sensor 112 by a coefficient set in advance for each type of vehicle. The humidity correction term is a value defined by, for example, multiplying the humidity in the vehicle cabin that is detected by the humidity sensor 113 by a coefficient set in advance for each type of vehicle. Each coefficient is set in advance through experiment or simulation for each type of vehicle. The constant in Expression (1) is also set in advance through experiment or simulation for each type of vehicle. The location correction term in Expression (2) is set in advance through experiment or simulation depending on whether the vehicle is adapted to cold climates or depending on a country where the vehicle is exported.

According to Expression (1), the basic term is calculated as a larger value and accordingly the necessary temperature adjustment control amount (TAOBiseat) is also calculated as a larger value as the vehicle cabin temperature term or the outside air temperature term decreases relative to the set temperature of the temperature adjustment air that is requested by the occupant M. There is a tendency that the warming request of the occupant M is at a higher level as the temperature in the vehicle cabin or the outside air temperature decreases relative to the set temperature of the temperature adjustment air that is requested by the occupant M. In this case, the necessary temperature adjustment control amount (TAOBiseat) is calculated as a larger value to increase a target blowing temperature and a target blowing amount of the temperature adjustment air, thereby sufficiently responding to the warming request of the occupant M (the relationship between the necessary temperature adjustment control amount and each of the target blowing temperature and the target blowing amount of the temperature adjustment air is described later).

Similarly, according to Expression (2), the necessary temperature adjustment control amount (TAOBiseat) is calculated as a larger value as the solar radiation amount correction term decreases. There is a tendency that the warming request of the occupant M is at a higher level as the solar radiation amount decreases, for example, in winter. In this case as well, the necessary temperature adjustment control amount (TAOBiseat) is calculated as a larger value to increase the target blowing temperature and the target blowing amount of the temperature adjustment air, thereby sufficiently responding to the warming request of the occupant M.

The necessary temperature adjustment control amount (TAOBiseat) is calculated as a smaller value as the humidity correction term increases. For example, in winter, the occupant M may feel discomfort when temperature adjustment air having a relatively high temperature is blown toward the occupant M but the humidity of the temperature adjustment air is high. When the humidity in the vehicle cabin is high (the humidity of air in the vehicle cabin to be sucked by the blower fan 21 is high), the necessary temperature adjustment control amount (TAOBiseat) is calculated as a smaller value to reduce the target blowing temperature and the target blowing amount of the temperature adjustment air, thereby suppressing discomfort of the occupant M.

The neck-heater necessary temperature adjustment control amount (NeckTAOi) is calculated by correcting the calculated necessary temperature adjustment control amount (TAOBiseat). The necessary temperature adjustment control amount (TAOBiseat) is corrected based on customization information received by the necessary temperature adjustment control amount correction unit 64. The customization information is input through an operation on the display 7 by the occupant M when the occupant M desires to change the blowing temperature and the blowing amount of the temperature adjustment air from the neck heater 2.

FIG. 5 is a diagram illustrating an example of an automatic mode customization setting table to be used for determining a value of a correction term for correcting the necessary temperature adjustment control amount (TAOBiseat) to determine the neck-heater necessary temperature adjustment control amount (NeckTAOi) when customization information is present (the occupant M operates the display 7 to input the customization information). A customization operation can be made through a display operation by the occupant M in two levels toward a higher temperature adjustment control ability, and in two levels toward a lower temperature adjustment control ability. In FIG. 5, “1” represents an operation input for increasing the temperature adjustment control ability by one level, “2” represents an operation input for increasing the temperature adjustment control ability by two levels, “−1” represents an operation input for reducing the temperature adjustment control ability by one level, and “−2” represents an operation input for reducing the temperature adjustment control ability by two levels.

When the operation input is “1”, the value of the correction term is “5”, and the neck-heater necessary temperature adjustment control amount (NeckTAOi) is calculated by adding “5” to the necessary temperature adjustment control amount (TAOBiseat). When the operation input is “2”, the value of the correction term is “10”, and the neck-heater necessary temperature adjustment control amount (NeckTAOi) is calculated by adding “10” to the necessary temperature adjustment control amount (TAOBiseat). When the operation input is “−1”, the value of the correction term is “−5”, and the neck-heater necessary temperature adjustment control amount (NeckTAOi) is calculated by subtracting “5” from the necessary temperature adjustment control amount (TAOBiseat). When the operation input is “−2”, the value of the correction term is “−10”, and the neck-heater necessary temperature adjustment control amount (NeckTAOi) is calculated by subtracting “10” from the necessary temperature adjustment control amount (TAOBiseat).

The calculated neck-heater necessary temperature adjustment control amount (NeckTAOi) is output to the temperature adjustment control basic value determination unit 65. When no customization information is present, the neck-heater necessary temperature adjustment control amount (NeckTAOi) is output to the temperature adjustment control basic value determination unit 65 as a value equal to the necessary temperature adjustment control amount (TAOBiseat). When the customization information is present, the neck-heater necessary temperature adjustment control amount (NeckTAOi) is output to the temperature adjustment control basic value determination unit 65 as a value obtained by correcting the necessary temperature adjustment control amount (TAOBiseat) based on the correction term (correction term determined by using the automatic mode customization setting table).

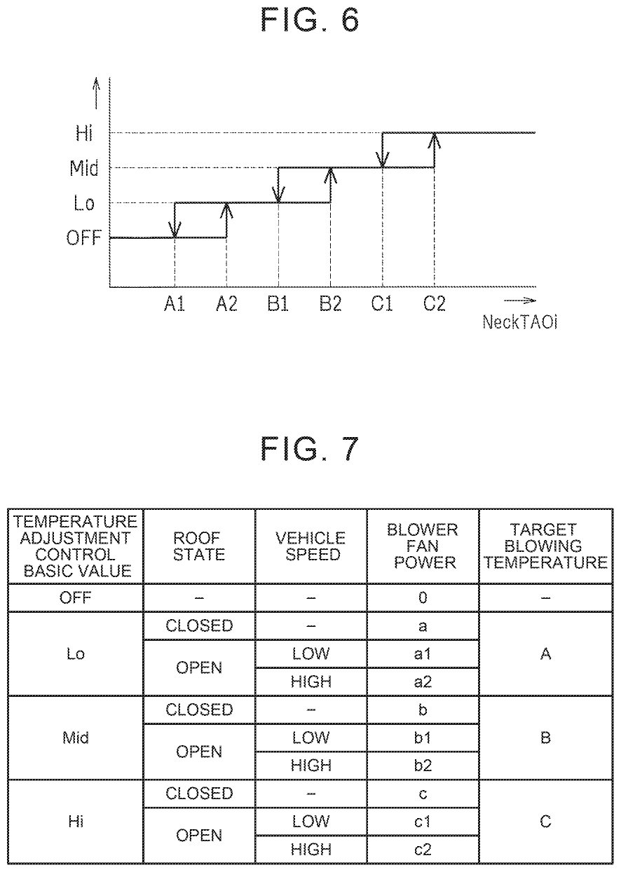

The temperature adjustment control basic value determination unit 65 determines a temperature adjustment control basic value based on the calculated neck-heater necessary temperature adjustment control amount (NeckTAOi). The temperature adjustment control basic value is used for determining which of the Lo mode, the Mid mode, and the Hi mode is set as the control mode of the neck heater 2. The temperature adjustment control basic value is determined by applying the neck-heater necessary temperature adjustment control amount (NeckTAOi) to a temperature adjustment control basic value determination map illustrated in FIG. 6.

The temperature adjustment control basic value determination map is used for setting the control mode of the neck heater 2 to “OFF”, the Lo mode, the Mid mode, or the Hi mode depending on the neck-heater necessary temperature adjustment control amount (NeckTAOi). In this embodiment, in a situation in which the neck-heater necessary temperature adjustment control amount (NeckTAOi) is increasing, the control mode of the neck heater 2 is switched from “OFF” to the Lo mode when the value of the neck-heater necessary temperature adjustment control amount (NeckTAOi) reaches “A2” in FIG. 6, from the Lo mode to the Mid mode when the value reaches “B2” in FIG. 6, and from the Mid mode to the Hi mode when the value reaches “C2” in FIG. 6. Hysteresis is provided in the mode switching. In a situation in which the neck-heater necessary temperature adjustment control amount (NeckTAOi) is decreasing, the Hi mode is kept until the value of the neck-heater necessary temperature adjustment control amount (NeckTAOi) reaches “C1” smaller than “C2” in FIG. 6, the Mid mode is kept until the value reaches “B1” smaller than “B2” in FIG. 6, and the Lo mode is kept until the value reaches “A1” smaller than “A2” in FIG. 6. Information on the determined control mode of the neck heater 2 is output from the air conditioner ECU 6 to the neck heater ECU 27.

The neck heater ECU 27 includes a target blowing temperature setting unit 27a and a target blowing amount setting unit 27b which contribute to the setting operation for the blowing temperature and the blowing amount in the automatic mode.

The target blowing temperature setting unit 27a sets a target blowing temperature of the temperature adjustment air from the neck heater 2 based on the temperature adjustment control basic value determined by the temperature adjustment control basic value determination unit 65. Specifically, the target blowing temperature is set by applying the temperature adjustment control basic value to a temperature adjustment control table illustrated in FIG. 7. In the temperature adjustment control table, the target blowing temperature is set as a higher value as the temperature adjustment control basic value increases. The target blowing temperature is set to “A” (for example, 37° C.) when the Lo mode is set based on the temperature adjustment control basic value. The target blowing temperature is set to “B” (for example, 40° C.) when the Mid mode is set. The target blowing temperature is set to “C” (for example, 43° C.) when the Hi mode is set. The values are not limited to those described above, but are set as appropriate.

The target blowing amount setting unit 27b sets a target blowing amount of the temperature adjustment air based on the temperature adjustment control basic value determined by the temperature adjustment control basic value determination unit 65, the signal output from the roof opening-closing switch 114, and the traveling speed of the vehicle that is detected by the vehicle speed sensor 115. Specifically, blower fan power (target blowing amount) is set by applying the temperature adjustment control basic value, the roof state, and the vehicle speed to the temperature adjustment control table illustrated in FIG. 7. In the temperature adjustment control table, the blower fan power is set as a larger value as the temperature adjustment control basic value increases. The blower fan power is set as a larger value when the movable roof is open rather than closed. The blower fan power is set as a larger value when the movable roof is open and the vehicle speed is equal to or higher than a predetermined value (for example, 50 km/h) rather than a case where the vehicle speed is lower than the predetermined value. When the movable roof is closed, the blower fan power is set as a value smaller than that in the case where the movable roof is open irrespective of the vehicle speed.

The neck heater ECU 27 includes a target blowing temperature reduction unit 27c. The target blowing temperature reduction unit 27c is configured to automatically reduce the target blowing temperature when an elapsed time reaches a predetermined time in a situation in which the neck heater 2 is operating in the Hi mode. If the blowing temperature of the temperature adjustment air from the neck heater 2 is relatively high continuously for a long time, the occupant M may be affected adversely (thermally affected adversely). Considering this possibility, the target blowing temperature is changed to a lower temperature under a condition that the elapsed time reaches the predetermined time in a state in which the target blowing temperature is equal to or higher than a predetermined temperature. Details of control for reducing the target blowing temperature are described later.

When the manual mode is selected through the operation on the display 7, the automatic/manual mode commanding unit 61 transmits the manual mode command signal to operate the neck heater 2 in the manual mode.

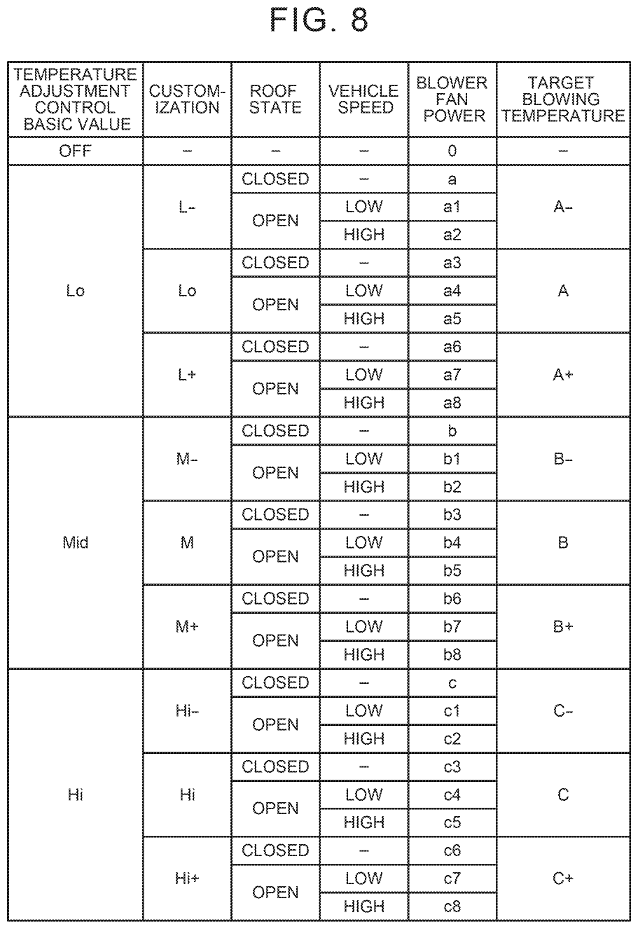

FIG. 8 is a diagram illustrating an example of a manual mode customization setting table to be used for setting the blower fan power (target blowing amount) and the target blowing temperature in the manual mode.

FIG. 8 demonstrates that the target blowing temperature is set as a higher value in the manual mode as the temperature adjustment control basic value increases.

The target blowing temperature is set to “A” (for example, 37° C.) when the Lo mode is set through the operation on the display 7 and no customization information is present (the mode is “Lo” after customization). The target blowing temperature is set to “A−” (for example, 36° C.) when customization information for reducing the temperature adjustment control ability by one level is present (the mode is “L−” after customization). The target blowing temperature is set to “A+” (for example, 38° C.) when customization information for increasing the temperature adjustment control ability by one level is present (the mode is “L+” after customization). The target blowing temperature is set to “B” (for example, 40° C.) when the Mid mode is set and no customization information is present (the mode is “M” after customization). The target blowing temperature is set to “B−” (for example, 39° C.) when customization information for reducing the temperature adjustment control ability by one level is present (the mode is “M−” after customization). The target blowing temperature is set to “B+” (for example, 41° C.) when customization information for increasing the temperature adjustment control ability by one level is present (the mode is “M+” after customization). The target blowing temperature is set to “C” (for example, 43° C.) when the Hi mode is set and no customization information is present (the mode is “Hi” after customization). The target blowing temperature is set to “C−” (for example, 42° C.) when customization information for reducing the temperature adjustment control ability by one level is present (the mode is “Hi−” after customization). The target blowing temperature is set to “C+” (for example, 44° C.) when customization information for increasing the temperature adjustment control ability by one level is present (the mode is “Hi+” after customization).

In the manual mode, the target blowing amount of the temperature adjustment air is set based on the control mode, the signal output from the roof opening-closing switch 114, and the traveling speed of the vehicle that is detected by the vehicle speed sensor 115. Specifically, the blower fan power (target blowing amount) is set by applying the control mode, the customization information, the roof state, and the vehicle speed to the manual mode customization setting table illustrated in FIG. 8. In the manual mode customization setting table, the blower fan power is set as a larger value in the order of L−, Lo, L+, M−, M, M+, Hi−, Hi, and Hi+. The blower fan power is set as a larger value when the movable roof is open rather than closed. The blower fan power is set as a larger value when the movable roof is open and the vehicle speed is equal to or higher than the predetermined value (for example, 50 km/h) rather than the case where the vehicle speed is lower than the predetermined value. When the movable roof is closed, the blower fan power is set as a value smaller than that in the case where the movable roof is open irrespective of the vehicle speed.

### Procedure of Neck Heater Control

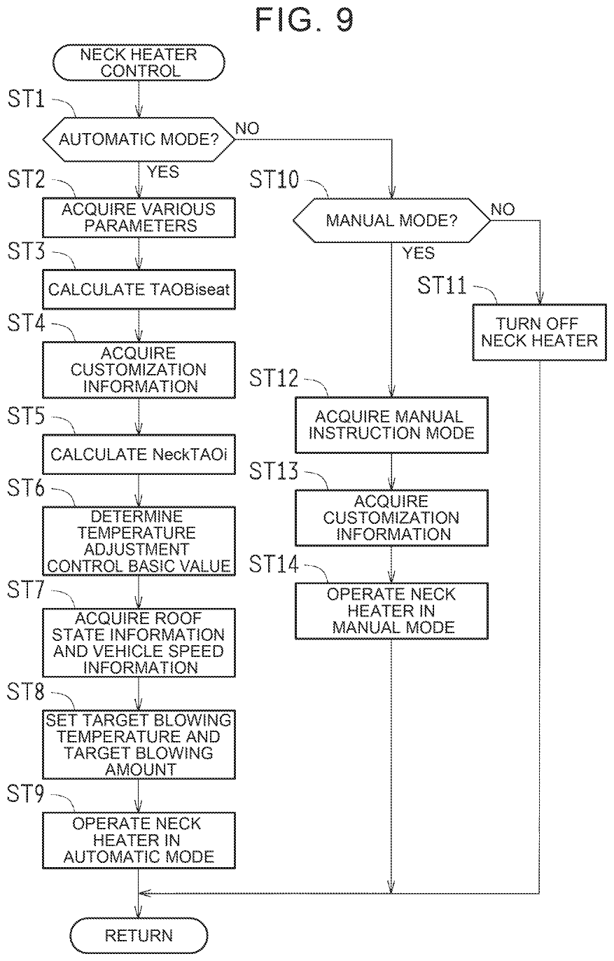

Next, a procedure of the neck heater control is described with reference to a flowchart of FIG. 9. In this flowchart, the neck heater control is repeated in every predetermined time by the air conditioner ECU 6 and the neck heater ECU 27 in a state in which the temperature adjustment system 1 is operated and a set temperature is set through a display operation by the occupant M.

In Step ST1, determination is first made whether the control mode of the neck heater 2 is currently the automatic mode. Specifically, the result of the determination in Step ST1 is “YES” when the control mode of the neck heater 2 is selected as the automatic mode in a situation in which the control modes of the temperature adjustment devices 2, 3, 4, and 5 are individually selected through display operations by the occupant M. The result of the determination in Step ST1 is also “YES” when the fully automatic mode switch is pressed (an operation is performed to set the control modes of all the temperature adjustment devices 2, 3, 4, and 5 to the automatic modes).

When the result of the determination in Step ST1 is “YES” because the control mode of the neck heater 2 is currently the automatic mode, the operation proceeds to Step ST2, and various parameters are acquired. Specifically, the acquired parameters are a temperature in the vehicle cabin that is detected by the vehicle cabin temperature sensor 110, an outside air temperature detected by the outside air temperature sensor 111, a solar radiation amount detected by the solar radiation amount sensor 112, a humidity in the vehicle cabin that is detected by the humidity sensor 113, a traveling speed of the vehicle that is detected by the vehicle speed sensor 115, and movable roof state information obtained based on a signal output from the roof opening-closing switch 114.

Then, the operation proceeds to Step ST3, and a necessary temperature adjustment control amount (TAOBiseat) is calculated based on Expressions (1) and (2).

Then, the operation proceeds to Step ST4. When customization information is present through a display operation by the occupant M, the customization information is acquired, and the operation proceeds to Step ST5. When no customization information is present, the operation proceeds to Step ST5 without any action.

In Step ST5, a neck-heater necessary temperature adjustment control amount (NeckTAOi) is calculated depending on whether the customization information is present. When no customization information is present, the neck-heater necessary temperature adjustment control amount (NeckTAOi) is equal to the necessary temperature adjustment control amount (TAOBiseat). When the customization information is present, the neck-heater necessary temperature adjustment control amount (NeckTAOi) is calculated through correction using a correction term determined from the automatic mode customization setting table illustrated in FIG. 5.

Then, the operation proceeds to Step ST6, and a temperature adjustment control basic value is determined by applying the neck-heater necessary temperature adjustment control amount (NeckTAOi) to the temperature adjustment control basic value determination map illustrated in FIG. 6. That is, the control mode of the neck heater 2 is set to the Lo mode, the Mid mode, or the Hi mode.

After the control mode of the neck heater 2 is set, the operation proceeds to Step ST7, and roof state information and vehicle speed information are acquired. The operation proceeds to Step ST8, and blower fan power and a target blowing temperature are acquired based on the temperature adjustment control table illustrated in FIG. 7. The blower fan 21 and the heater 22 are controlled by setting those values as a target blowing amount and a target blowing temperature. Thus, the neck heater 2 operates in the automatic mode (Step ST9).

When the result of the determination in Step ST1 is “NO” because the control mode of the neck heater 2 is not currently the automatic mode, the operation proceeds to Step ST10, and determination is made whether the control mode of the neck heater 2 is currently the manual mode. Specifically, determination is made whether the control mode of the neck heater 2 is set to the manual mode through a display operation by the occupant M. When the result of the determination in Step ST10 is “NO” because the control mode of the neck heater 2 is not currently the manual mode, that is, when the control mode of the neck heater 2 is neither the automatic mode nor the manual mode, the operation proceeds to Step ST11, and the neck heater 2 is stopped (OFF).

When the result of the determination in Step ST10 is “YES” because the control mode of the neck heater 2 is currently the manual mode, the operation proceeds to Step ST12, and a control mode specified through a display operation by the occupant M (manual instruction mode) is acquired. The operation proceeds to Step ST13. When customization information is present through a display operation by the occupant M, the customization information is acquired, and the operation proceeds to Step ST14. When no customization information is present, the operation proceeds to Step ST14 without any action.

In Step ST14, blower fan power and a target blowing temperature are acquired based on the manual mode customization setting table illustrated in FIG. 8 depending on the manual instruction mode acquired in Step ST12 and depending on whether the customization information is acquired in Step ST13. The blower fan 21 and the heater 22 are controlled by setting those values as a target blowing amount and a target blowing temperature. Thus, the neck heater 2 operates in the manual mode (Step ST14).

The operation described above is repeated, and the neck heater 2 is controlled in the automatic mode or the manual mode to blow temperature adjustment air toward the neck of the occupant M. Thus, comfort around the neck of the occupant M is secured.

### Procedure of Neck Heater Temperature Reduction Control

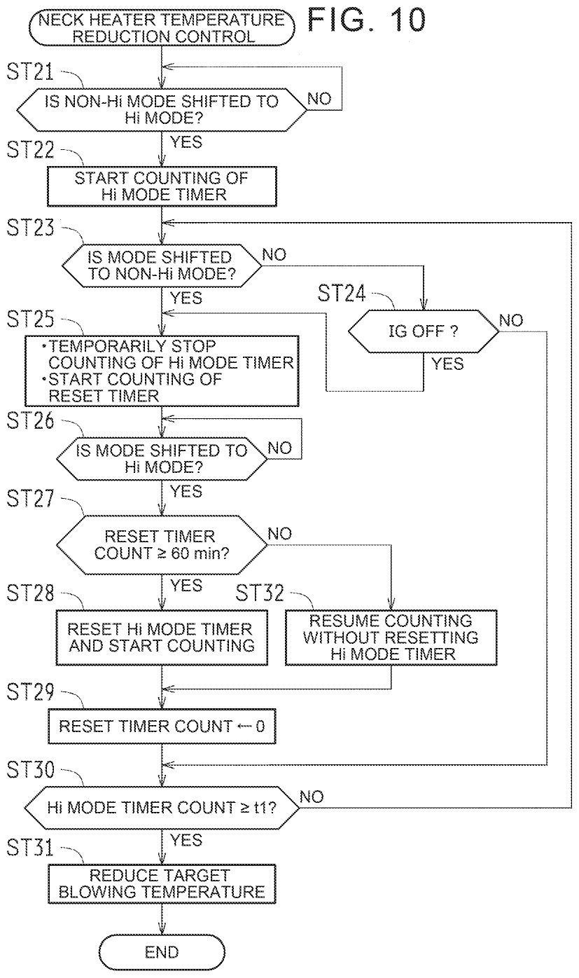

Next, a procedure of the neck heater temperature reduction control to be executed by the target blowing temperature reduction unit 27c is described with reference to a flowchart of FIG. 10. In this flowchart, the neck heater temperature reduction control is executed while the neck heater 2 is operating (in the automatic mode or the manual mode).

In Step ST21, determination is first made whether the control mode of the neck heater 2 is shifted to the Hi mode from a mode other than the Hi mode (non-Hi mode; including “OFF”). When the neck heater 2 is in the automatic mode, the determination is made based on a signal output from the temperature adjustment control basic value determination unit 65. When the neck heater 2 is in the manual mode, the determination is made by receiving information on a display operation by the occupant M via the air conditioner ECU 6.

When the result of the determination in Step ST21 is “YES” because the control mode of the neck heater 2 is shifted to the Hi mode from the non-Hi mode, the operation proceeds to Step ST22, and a Hi mode timer provided in advance in the neck heater ECU 27 starts counting. The Hi mode timer terminates the counting when a predetermined time (t1) is counted.

Then, the operation proceeds to Step ST23, and determination is made whether the control mode of the neck heater 2 is shifted to a non-Hi mode from the Hi mode. When the neck heater 2 is in the automatic mode, the determination is made based on a signal output from the temperature adjustment control basic value determination unit 65. When the neck heater 2 is in the manual mode, the determination is made by receiving information on a display operation by the occupant M via the air conditioner ECU 6.

When the result of the determination in Step ST23 is “YES” because the control mode of the neck heater 2 is shifted to the non-Hi mode from the Hi mode, the operation proceeds to Step ST25. When the control mode of the neck heater 2 is not shifted to the non-Hi mode from the Hi mode, the result of the determination in Step ST23 is “NO”, and the operation proceeds to Step ST24. In Step ST24, determination is made whether an ignition switch of the vehicle is turned OFF. When the result of the determination in Step ST24 is “YES” because the ignition switch of the vehicle is turned OFF, the operation proceeds to Step ST25.

When the ignition switch of the vehicle is not turned OFF, that is, when the control mode of the neck heater 2 is kept as the Hi mode, the result of the determination in Step ST24 is “NO”. The operation proceeds to Step ST30, and determination is made whether the count of the Hi mode timer reaches the predetermined time (t1). That is, determination is made whether the duration of the Hi mode as the control mode of the neck heater 2 reaches the predetermined time (t1).

When the result of the determination in Step ST30 is “YES” because the count of the Hi mode timer reaches the predetermined time (t1), the operation proceeds to Step ST31, and a target blowing temperature reduction operation is executed so that the target blowing temperature is set lower by a predetermined value. For example, the target blowing temperature is set lower by 3° C. The value is not limited to this value, but is set as appropriate.

When the operation proceeds to Step ST25 because the control mode of the neck heater 2 is shifted to the non-Hi mode from the Hi mode or because the ignition switch of the vehicle is turned OFF, the counting of the Hi mode timer is temporarily stopped and a reset timer provided in advance in the neck heater ECU 27 starts counting in Step ST25. The reset timer terminates the counting when a predetermined time (for example, 60 minutes) is counted.

Then, the operation proceeds to Step ST26, and determination is made whether the control mode of the neck heater 2 is shifted to the Hi mode from the non-Hi mode.

When the result of the determination in Step ST26 is “YES” because the control mode of the neck heater 2 is shifted to the Hi mode from the non-Hi mode, the operation proceeds to Step ST27, and determination is made whether the count of the reset timer reaches the predetermined time (60 minutes). That is, determination is made whether the control mode of the neck heater 2 is shifted to the non-Hi mode and is then shifted to the Hi mode again after an elapse of the predetermined time (60 minutes).

When the result of the determination in Step ST27 is “YES” because the count of the reset timer reaches the predetermined time (60 minutes), the operation proceeds to Step ST28. The Hi mode timer is reset (the count value is reset to 0), and the Hi mode timer starts counting again. When the result of the determination in Step ST27 is “NO” because the count of the reset timer does not reach the predetermined time (60 minutes), the operation proceeds to Step ST32. The Hi mode timer resumes the counting without resetting the Hi mode timer. That is, the Hi mode timer resumes the counting from the count value that is temporarily stopped in Step ST25.

In the operation of Step ST28, when the control mode of the neck heater 2 is shifted to the non-Hi mode and is then shifted to the Hi mode again after the elapse of the predetermined time (60 minutes), temperature adjustment air having a relatively high temperature is not blown toward the neck of the occupant M for a long time. Therefore, the Hi mode timer is reset and starts counting again under the assumption that the occupant M is hardly affected adversely even if the mode is shifted to the Hi mode again. In the operation of Step ST32, when the control mode of the neck heater 2 is shifted to the non-Hi mode and is then shifted to the Hi mode again without the elapse of the predetermined time (60 minutes), the occupant M may be affected adversely. Considering this possibility, the Hi mode timer resumes the counting without resetting the Hi mode timer so that the count of the Hi mode timer reaches the predetermined time (t1) in an early period.

After the counting of the Hi mode timer is started, the count of the reset timer is reset to “0” in Step ST29. The operation proceeds to Step ST30, and determination is made whether the count of the Hi mode timer reaches the predetermined time (t1). When the Hi mode timer is reset because the count of the reset timer reaches the predetermined time (60 minutes) in Step ST27, determination is made whether an elapsed time from the start of counting of the Hi mode timer in Step ST28 reaches the predetermined time (t1). When the Hi mode timer resumes the counting in Step ST32 without resetting the Hi mode timer because the count of the reset timer does not reach the predetermined time (60 minutes) in Step ST27, determination is made whether a time obtained by summing the time from the start of counting of the Hi mode timer in Step ST22 to the temporary stop of the counting of the Hi mode timer in Step ST25 and the time after the Hi mode timer resumes the counting in Step ST32 reaches the predetermined time (t1).

In Step ST30, determination is made whether the count of the Hi mode timer reaches the predetermined time (t1) as described above. When the result of the determination in Step ST30 is “YES” because the count of the Hi mode timer reaches the predetermined time (t1), the operation proceeds to Step ST31, and the target blowing temperature reduction operation is executed so that the target blowing temperature is set lower by the predetermined value. When the result of the determination in Step ST30 is “NO” because the count of the Hi mode timer does not reach the predetermined time (t1), the operation returns to Step ST23, and the operation described above is repeated.

According to the neck heater temperature reduction control, it is possible to avoid the situation in which the blowing temperature of the temperature adjustment air from the neck heater 2 is relatively high continuously for a long time. Thus, the adverse effect on the occupant M can be suppressed.

### Effects of Embodiment

As described above, in this embodiment, the blowing temperature of the temperature adjustment air to be blown from the neck heater 2 is controlled based on the temperature adjustment control basic value determined by the temperature adjustment control basic value determination unit 65. Further, the blowing amount of the temperature adjustment air when the movable roof is open or the blowing amount of the temperature adjustment air when the movable roof is closed is controlled based on the temperature adjustment control basic value determined by the temperature adjustment control basic value determination unit 65 (based on the temperature adjustment control basic value, the open-closed state of the movable roof, and the vehicle speed). That is, each control is performed based on the temperature adjustment control basic value. Therefore, when the movable roof is opened or closed, the temperature adjustment condition of the neck heater 2 does not change significantly in response to the change in the state of the movable roof (before and after the movable roof is opened or closed). As a result, discomfort of the occupant M is suppressed. Thus, the temperature adjustment control can be performed without causing discomfort in the occupant M irrespective of whether the movable roof is open or closed. The temperature adjustment control is automatically performed by the target blowing temperature setting unit 27a and the target blowing amount setting unit 27b, and therefore the occupant M is not forced to perform a burdensome operation. Thus, a highly useful temperature adjustment device controller can be provided.

In this embodiment, the control for changing the target blowing temperature to a lower temperature is performed under the condition that the elapsed time reaches the predetermined time in the state in which the target blowing temperature is equal to or higher than the predetermined temperature. Thus, it is possible to suppress the adverse effect on the occupant M that may be caused by the situation in which the blowing temperature of the temperature adjustment air from the neck heater 2 is relatively high continuously for a long time.

In this embodiment, the neck-heater necessary temperature adjustment control amount (NeckTAOi) is calculated by correcting the necessary temperature adjustment control amount (TAOBiseat) based on the customization information input through the manual operation by the occupant M. Thus, the request to change the temperature adjustment air from the occupant M can be met satisfactorily.

### Other Embodiments

The disclosure is not limited to the embodiment described above, but encompasses all modifications and applications within the scope of claims and their equivalents.

For example, in the embodiment described above, the temperature in the vehicle cabin, the outside air temperature, the solar radiation amount, and the humidity in the vehicle cabin are exemplified as the parameters including the environmental information to be acquired by the parameter acquisition unit 62. The parameters including the environmental information are not limited to those parameters. For example, at least one of those parameters or other parameters may be employed.

In the embodiment described above, description is given of the neck heater 2 applied to the front seat of the vehicle. If the vehicle has a rear seat, the neck heater may be applied to the rear seat, and the disclosure may be applied as a controller for this neck heater.

In the embodiment described above, description is given of the case where the disclosure is applied to the controller (temperature adjustment device controller) configured to control the blowing temperature and the blowing amount of the temperature adjustment air to be blown from the neck heater 2. In addition, the disclosure may be applied to the vehicle cabin air conditioner 3 that is another temperature adjustment device. That is, a target blowing temperature and a target blowing amount of the vehicle cabin air conditioner 3 are controlled based on the temperature adjustment control basic value. Further, the disclosure may be applied to the seat air conditioner 4. That is, a target temperature of the seat air conditioner 4 (target temperature of the seat heater 41) and a target blowing amount of the seat air conditioner 4 (target blowing amount of the blower fan 42) are controlled based on the temperature adjustment control basic value. Still further, the disclosure may be applied to the steering heater 5. That is, a target temperature of the steering heater 5 (target temperature of the heater 51) is controlled based on the temperature adjustment control basic value.

In the embodiment described above, the necessary temperature adjustment control amount correction unit 64 and the temperature adjustment control basic value determination unit 65 are provided in the air conditioner ECU 6, but may be provided in the neck heater ECU 27.

The disclosure is applicable to a temperature adjustment device controller configured to control a blowing temperature and a blowing amount of temperature adjustment air to be blown from a temperature adjustment device such as a neck heater mounted on a convertible vehicle.

What is claimed is:

1. A temperature adjustment device controller configured to control a blowing temperature and a blowing amount of temperature adjustment air to be blown into a vehicle cabin from a temperature adjustment device mounted on a convertible vehicle having a movable roof that is openable and closable, the temperature adjustment device controller comprising:
a parameter acquisition unit configured to acquire a parameter including environmental information;
a necessary temperature adjustment control amount calculation unit configured to calculate a necessary temperature adjustment control amount based on the parameter acquired by the parameter acquisition unit;
a temperature adjustment control basic value determination unit configured to determine a temperature adjustment control basic value based on the necessary temperature adjustment control amount calculated by the necessary temperature adjustment control amount calculation unit;
roof opening-closing switch configured to output an output signal depending on an open-closed state of the movable roof;
vehicle speed detection sensor configured to detect a vehicle speed;
a target blowing temperature setting unit configured to set a target blowing temperature of the temperature adjustment air based on the temperature adjustment control basic value determined by the temperature adjustment control basic value determination unit; and
a target blowing amount setting unit configured to set a target blowing amount of the temperature adjustment air based on the temperature adjustment control basic value determined by the temperature adjustment control basic value determination unit, the open-closed state of the movable roof that is output by the roof opening-closing switch, and the vehicle speed detected by the vehicle speed detection sensor.

2. The temperature adjustment device controller according to claim 1, wherein:
the temperature adjustment device is configured to blow temperature adjustment air for warming into the vehicle cabin;
the parameter including the environmental information is an environmental temperature including at least one of a temperature in the vehicle cabin and an outside air temperature; and
the temperature adjustment device controller is configured to, as the environmental temperature decreases relative to a set temperature of the temperature adjustment air that is requested by an occupant, set the necessary temperature adjustment control amount calculated by the necessary temperature adjustment control amount calculation unit to a larger value, such that the temperature adjustment device controller increases the target blowing temperature of the temperature adjustment air set by the target blowing temperature setting unit and increases the target blowing amount of the temperature adjustment air set by the target blowing amount setting unit.

3. The temperature adjustment device controller according to claim 1, wherein:
the temperature adjustment device is configured to blow temperature adjustment air for warming into the vehicle cabin;
the parameter including the environmental information is a solar radiation amount in the vehicle cabin; and
the temperature adjustment device controller is configured to, as the solar radiation amount decreases, set the necessary temperature adjustment control amount calculated by the necessary temperature adjustment control amount calculation unit to a larger value, such that the temperature adjustment device controller increases the target blowing temperature of the temperature adjustment air set by the target blowing temperature setting unit and increases the target blowing amount of the temperature adjustment air set by the target blowing amount setting unit.

4. The temperature adjustment device controller according to claim 1, wherein:
the temperature adjustment device is configured to blow temperature adjustment air for warming into the vehicle cabin;
the parameter including the environmental information is a humidity in the vehicle cabin; and
the temperature adjustment device controller is configured to, as the humidity increases, set the necessary temperature adjustment control amount calculated by the necessary temperature adjustment control amount calculation unit to a smaller value, such that the temperature adjustment device controller reduces the target blowing temperature of the temperature adjustment air set by the target blowing temperature setting unit and the target blowing amount of the temperature adjustment air set by the target blowing amount setting unit.

5. The temperature adjustment device controller according to claim 1, wherein the temperature adjustment device controller is configured to, when the open-closed state of the movable roof that is recognized based on the output signal from the roof opening-closing switch is an open state rather than a closed state, perform control so as to increase the target blowing amount of the temperature adjustment air set by the target blowing amount setting unit, even when the temperature adjustment control basic value determined by the temperature adjustment control basic value determination unit is the same.

6. The temperature adjustment device controller according to claim 1, wherein the temperature adjustment device controller is configured to, when the open-closed state of the movable roof that is recognized based on the output signal from the roof opening-closing switch is an open state, perform control so as to increase the target blowing amount of the temperature adjustment air set by the target blowing amount setting unit increases as the vehicle speed detected by the vehicle speed detection sensor, even when the temperature adjustment control basic value determined by the temperature adjustment control basic value determination unit is the same.

7. The temperature adjustment device controller according to claim 1, wherein the temperature adjustment device is a neck heater provided in a head rest of a seat in the vehicle cabin and configured to blow the temperature adjustment air forward from the head rest.

8. The temperature adjustment device controller according to claim 7, further comprising a target blowing temperature reduction unit configured to change the target blowing temperature to a lower temperature under a condition that an elapsed time reaches a predetermined time in a state where the target blowing temperature is equal to or higher than a predetermined temperature.

9. The temperature adjustment device controller according to claim 1, further comprising a necessary temperature adjustment control amount correction unit configured to
receive customization information for the temperature adjustment air that is input through a manual operation by an occupant, and
correct the necessary temperature adjustment control amount based on the customization information.

10. The temperature adjustment device controller according to claim 1, wherein the temperature adjustment device controller is configured to adjust control parameters of temperature adjustment devices mounted on the convertible vehicle based on the necessary temperature adjustment control amount calculated by the necessary temperature adjustment control amount calculation unit.

11. A temperature adjustment device controller comprising at least one electronic control unit configured to:
control a blowing temperature and a blowing amount of temperature adjustment air to be blown into a vehicle cabin from a temperature adjustment device mounted on a convertible vehicle having a movable roof that is openable and closable;
acquire a parameter including environmental information;
calculate a necessary temperature adjustment control amount based on the parameter;
determine a temperature adjustment control basic value based on the necessary temperature adjustment control amount;
output an output signal depending on an open-closed state of the movable roof;
detect a vehicle speed;
set a target blowing temperature of the temperature adjustment air based on the temperature adjustment control basic value; and
set a target blowing amount of the temperature adjustment air based on the temperature adjustment control basic value, the open-closed state of the movable roof, and the vehicle speed.

12. The temperature adjustment device controller according to claim 11, wherein:
the temperature adjustment device is configured to blow temperature adjustment air for warming into the vehicle cabin;
the parameter including the environmental information is an environmental temperature including at least one of a temperature in the vehicle cabin and an outside air temperature; and
the temperature adjustment device controller is configured to, as the environmental temperature decreases relative to a set temperature of the temperature adjustment air that is requested by an occupant, set the necessary temperature adjustment control amount calculated by the at least one electronic control unit to a larger value, such that the temperature adjustment device controller increases the target blowing temperature of the temperature adjustment air set by the at least one electronic control unit and increases the target blowing amount of the temperature adjustment air set by the at least one electronic control unit.

13. The temperature adjustment device controller according to claim 11, wherein:
the temperature adjustment device is configured to blow temperature adjustment air for warming into the vehicle cabin;
the parameter including the environmental information is a solar radiation amount in the vehicle cabin; and
the temperature adjustment device controller is configured to, as the solar radiation amount decreases, set the necessary temperature adjustment control amount calculated by the at least one electronic control unit to a larger value, such that the temperature adjustment device controller increases the target blowing temperature of the temperature adjustment air set by the at least one electronic control unit and increases the target blowing amount of the temperature adjustment air set by the at least one electronic control unit.

14. The temperature adjustment device controller according to claim 11, wherein:
the temperature adjustment device is configured to blow temperature adjustment air for warming into the vehicle cabin;
the parameter including the environmental information is a humidity in the vehicle cabin; and
the temperature adjustment device controller is configured to, as the humidity increases, set the necessary temperature adjustment control amount calculated by the at least one electronic control unit to a smaller value, such that the temperature adjustment device controller reduces the target blowing temperature of the temperature adjustment air set by the at least one electronic control unit and reduces the target blowing amount of the temperature adjustment air set by the at least one electronic control unit.

15. The temperature adjustment device controller according to claim 11, wherein the temperature adjustment device controller is configured to, when the open-closed state of the movable roof is an open state rather than a closed state, perform control the target blowing amount of the temperature adjustment air set by the at least one electronic control unit increases even when the temperature adjustment control basic value determined by the at least one electronic control unit is the same.

16. The temperature adjustment device controller according to claim 11, wherein the temperature adjustment device controller is configured to, when the open-closed state of the movable roof is an open state, perform control the target blowing amount of the temperature adjustment air set by the at least one electronic control unit increases as the vehicle speed increases, even when the temperature adjustment control basic value determined by the at least one electronic control unit is the same.

17. The temperature adjustment device controller according to claim 11, wherein the temperature adjustment device is a neck heater provided in a head rest of a seat in the vehicle cabin and configured to blow the temperature adjustment air forward from the head rest.

18. The temperature adjustment device controller according to claim 17, wherein the at least one electronic control unit is configured to change the target blowing temperature to a lower temperature under a condition that an elapsed time reaches a predetermined time in a state where the target blowing temperature is equal to or higher than a predetermined temperature.

19. The temperature adjustment device controller according to claim 11, wherein the at least one electronic control unit is configured to:
receive customization information for the temperature adjustment air that is input through a manual operation by an occupant, and
correct the necessary temperature adjustment control amount based on the customization information.

20. The temperature adjustment device controller according to claim 11, wherein the temperature adjustment device controller is configured to adjust control parameters of temperature adjustment devices mounted on the convertible vehicle based on the necessary temperature adjustment control amount calculated by the at least one electronic control unit.
